(19) United States
(12) Patent Application Publication
(10) Pub. No.: US 2026/0010917 A1
(43) Pub. Date: Jan. 8, 2026

(54) SYSTEM, METHOD AND COMPUTER PROGRAM PRODUCT FOR IDENTITY AND ASSIGNMENT VERIFICATION OF CUSTOMER SERVICE AGENTS AND CALLERS

(71) Applicant: Ajay Sagar, Westborough, MA (US)

(72) Inventor: Ajay Sagar, Westborough, MA (US)

(21) Appl. No.: 18/765,290

(22) Filed: Jul. 7, 2024

(51) Int. Cl. G06Q 30/018; G06Q 10/0631; G06Q 30/015

(52) U.S. Cl. CPC G06Q 30/0185; G06Q 10/06311; G06Q 30/015

(57) ABSTRACT

The purpose of the invention is to provide a secure and efficient method of identity verification for customer service agents and callers. The system enables businesses to securely assign customer service assignments to their agents and enables customers to verify the identity of the customer service agent who contacts them. The invention aims to prevent fraud, safeguard customer privacy, and prevent deceitful persons or entities from posing as legitimate business representatives to extort money or other benefits from customers. This invention streamlines the identity verification process for businesses and their customers, and enables caller introduction, purpose, and verification to be achieved in a single session.

### FIELD OF THE INVENTION

The present invention relates to a system, method, and computer program product to provide a secure and efficient means of identity verification for customer service agents and callers by facilitating business to securely assign customer service assignments to their agents and enables customers to verify the identity of the customer service agent who contacts them.

### BACKGROUND OF THE INVENTION

Fraud by customer service agents and callers is a growing concern for businesses and consumers alike. Customer service agents are in a unique position of trust, as they have access to sensitive information and the ability to perform various transactions on behalf of customers. Callers can also use social engineering tactics to gain access to sensitive information or trick customer service agents into performing fraudulent activities. Unscrupulous individuals/entities claiming to represent business and government agencies are continuously finding new ways to scam innocent individuals. This has become a significant problem in recent years, with many victims losing their hard earned money and sensitive information to fraudsters. In particular, the recent fraud incidents related to Amazon, IRS, and SSA have caused a significant impact on the lives of many individuals. These unscrupulous persons/entities have used the names of these agencies to trick people into providing their personal and financial information, leading to severe consequences for the victims.

There are several types of fraud by customer service agents and callers including but not limited to:
Account Takeover Fraud: Customer service agents have access to account information and can easily change passwords or add new authorized users. Fraudulent agents can take over accounts and change contact information, making it difficult for the actual account holder to regain access.
Unauthorized Transactions: Fraudulent customer service agents may process unauthorized transactions on behalf of customers, such as transferring funds or changing account information.
Information Theft: Customer service agents may steal sensitive information, such as social security numbers or credit card information, and use it for personal gain or sell it on the dark web.
Insider Trading: Customer service agents may use their access to privileged information to make trades or investments, which is illegal and can harm the company and its customers.
Phishing: Callers may impersonate a legitimate company and ask for personal information, such as account numbers or passwords. They may also ask the victim to download malware or click on a malicious link, which can infect their device and steal their information.
Social Engineering: Callers may use psychological tactics to gain access to sensitive information or convince the customer service agent to perform fraudulent activities, such as posing as a supervisor or threatening legal action.
Impersonation: Callers may impersonate a legitimate account holder or authorized user to gain access to the account or make unauthorized transactions.

There are several recent incidents of fraud such as in February 2021, a woman was scammed out of nearly $10,000 by someone posing as an Amazon employee. The scammer convinced her to download a remote access application to her computer and stole her personal and financial information. In November 2020, a woman in California was scammed out of nearly $200,000 by someone posing as a representative from the Social Security Administration. The scammer convinced her that her identity had been stolen and that she needed to transfer money to a “safe” account. In September 2020, a woman in the US was scammed out of $5,000 by someone posing as a representative from the IRS. The scammer convinced her that she owed back taxes and that she needed to make a payment immediately.

There are several methods fraudsters adopt to trap innocent people:
IRS—Fraudsters often claim to be representatives from the Internal Revenue Service (IRS) and tell people that they owe back taxes or have a refund waiting. They then ask for personal information or payment in order to process the refund or avoid legal action.
Federal Bureau of Investigation (FBI)—Fraudsters have claimed to be representatives from the FBI and told people that they are under investigation for a crime. They then ask for personal information or payment in order to resolve the issue.
United States Citizenship and Immigration Services (USCIS)—Fraudsters have claimed to be representatives from the USCIS and told people that they need to pay a fee in order to renew their visa or immigration status. They then ask for personal information or payment in order to resolve the issue.
Banks—Fraudsters have posed as representatives from banks and told people that their account has been compromised or that they need to transfer their money to a “safe” account. They then ask for personal information or payment in order to resolve the issue.
Social Security Administration—Fraudsters have posed as representatives from the Social Security Administration (SSA) and told people that their identity has been stolen or that their benefits have been compromised. They then ask for personal information or payment in order to resolve the issue.
Amazon—Fraudsters have pretended to be representatives from Amazon and told people that there is a problem with their account or that they need to pay for a service in order to keep their account active. They then ask for personal information or payment in order to resolve the issue.

To protect yourself from fraud by customer service agents and callers, it's important to be cautious when giving out personal information over the phone. Always verify the identity of the person you're speaking with, and never give out sensitive information unless you're sure you're speaking with a legitimate representative of the organization in question. Additionally, be wary of unsolicited calls or emails, and never click on links or download attachments from unknown sources.

If you suspect that you've been the victim of fraud, it's important to report it to the appropriate authorities as soon as possible. This can help prevent further damage and may also help to bring the perpetrators to justice.

In conclusion, fraud by customer service agents and callers is a serious problem that can have devastating consequences for victims. By being vigilant and taking steps to protect yourself, you can reduce your risk of falling prey to these scams and help to keep your personal and financial information safe.

### SUMMARY OF THE INVENTION

In an embodiment of the present invention, a user operates the system, a business or government agency first creates three roles: Assignment manager, Assignment approver, and Assignment owner (a.k.a Caller). An individual may assume one or more roles. The assignment manager logs in to System with their business SSO (Single Sign On) and creates service assignments for their customers, including identifying information such as the Assignment Owner's name, photo, employment type, employee ID, and assignment details such as the purpose and terms of the assignment.

The Assignment Approver then logs in to the system with their business SSO and approves or rejects the assignment. Once approved, the Assignment Owner logs in to the system with their business SSO to view the assigned assignment.

The Assignment Owner (a.k.a Caller) then contacts the customer and introduces themselves. They request that the customer validate their identity through the system to establish trust. Once the customer validates the identity, the Assignment Owner can then discuss the purpose of the call and any relevant information with the customer.

If the customer requests identity verification, the Assignment Owner generates an identity token through the System and communicates it to the customer over the phone, email, or other available communication channels. The Assignment Owner can also capture assignment outcome, next steps, and customer feedback in the System.

The customer can then log in to System with their mobile number and enter the identity token to view the assignment details. If the Assignment Owner's identity and assignment details are valid, the customer will see an assignment card with the Assignment Owner's name, employment type, ID, purpose of the call, privacy, and terms of the assignment. If the Assignment Owner or assignment details are not valid, the customer will see a fraud alert and have the option to report it to the agency. Trust is established between the Assignment Owner and the customer for a valid Assignment Owner identity and assignment, while fraud is prevented with the alert.

Overall, the system provides a streamlined and user-friendly means of identity verification and verified assignment, enabling businesses to prevent fraud, safeguard customer privacy, and prevent deceitful individuals or entities from posing as legitimate business representatives to extort money or other benefits from customers.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1 is a simplified block diagram of a server system, in accordance with one embodiment of the present disclosure;

FIG. 2 illustrates an exemplary embodiment of the assignment manager & assignment approver modules in accordance with an embodiment of the present invention;

FIG. 3 illustrates is an exemplary embodiment of the assignment owner (a.k.a. agent) module, flowchart from caller perspective establishing trust between caller and customer in accordance with an embodiment of the present invention;

FIG. 4 illustrates an exemplary flowchart from customer perspective, establishing trust between caller and customer according to various embodiments of the present invention when customer is registered and installed Mobile app on his/her phone;

FIG. 5 illustrates another exemplary flowchart from customer perspective, establishing trust between caller and customer according to various embodiments of the present invention when customer isn't registered;

FIG. 6 illustrates another exemplary flowchart from Legal business entities, Government agencies perspective establishing trust between them with their customer according to various embodiments of the present invention when mode of communication is other than phone call e.g. Post mail, Email, Text;

FIG. 7 illustrates an exemplary flowchart from customer perspective, establishing trust with Legal business entities, Government agencies, reporting fraud or feedback to agency according to an embodiment of the present invention; and

FIG. 8 is a simplified block diagram of an electronic device capable of implementing at least some embodiments of the present disclosure.

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

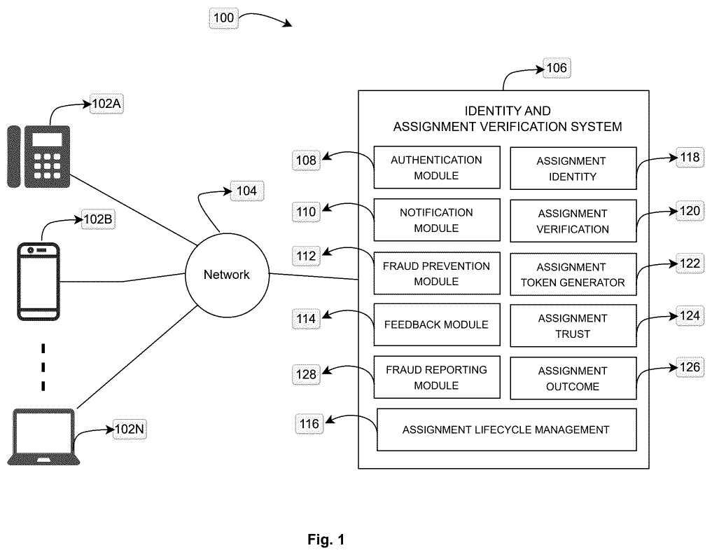

With reference now to the drawings, and in particular to FIG. 1 to FIG. 8 hereof, a system, method and computer program products for identity and assignment verification of customer service agents and callers embodying the principles and concepts of the present invention is described.

Reference is made now to FIG. 1, illustrating an exemplary embodiment 100 of identity and assignment verification system wherein the client device/terminal including but not limited to telephone 102a, smartphone 102b, tablet, phablet, laptop 102n, desktop etc. is communicably connected to caller/sender identity and assignment verification system. The network 104 may include but not limited to personal area network, local area network, wide area network, metropolitan area network etc. for exchange and transfer of information.

In an embodiment of the present invention, the caller/sender identity and assignment verification system include an authentication module 108, assignment identity module 118, notification module 110, assignment verification module 120, fraud prevention module 112, assignment token generator module 122, feedback module 114, assignment trust module 124, assignment outcome module 126, assignment lifecycle management module 116, fraud reporting module 128.

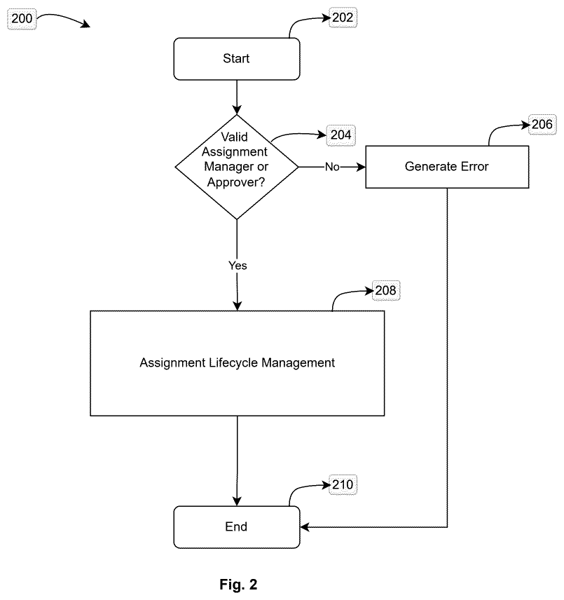

Reference is made now to FIG. 2, illustrating an embodiment 200 of the present invention wherein the process starts 202 by checking whether the assignment manager/assignment owner is valid or not at step 204. If assignment manager is log in to the system with business SSO and valid then assignment lifecycle management 208 facilitate assignment manager creates service assignments for customers, including identifying information such as Customer ID, Assignment Owner name, photo, employment type (Contractor/Full time), employee ID, assignment validity, purpose, privacy, and terms of assignment. The service assignment here represents a digital record created to hold details of caller, call receiver, calling purpose, terms, feedback and outcome. Digital identity validation here represents validation using legal entities/business SSO, government issued IDs, social network verified accounts and any other digital identities. Communication method may include phone/voip calls but not limited to other communication e.g. postal mail, e-mail, SMS etc. If the assignment approver logs in to the system with business SSO and valid then assignment approver approves or rejects the service assignment. If the assignment manager/approver is not valid then an error 206 is generated.

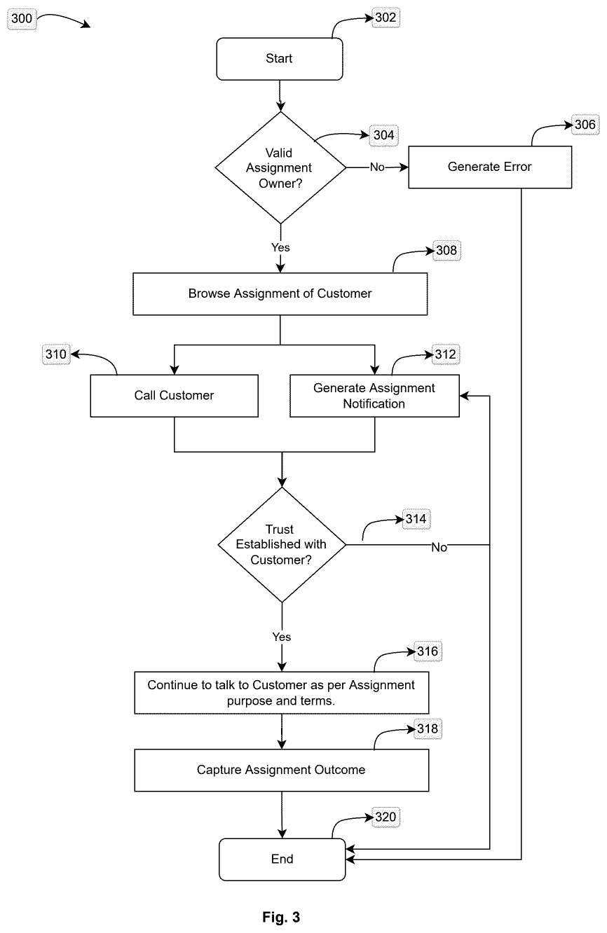

Reference is made now to FIG. 3 from assignment owner (a.k.a agent/caller) perspective, illustrating an embodiment 300 of the present invention wherein the process starts by checking the validity 304 of assignment owner (a.k.a caller) and if the assignment owner is not valid then an error 306 is generated by the system hence ending the process. If the assignment owner is log in to the system with business SSO and valid then assignment owner browses 308 for customer assignment. When the assignment owner calls 310 the customer, they introduce themselves and request the customer to validate their identity over system to establish trust. Assignment owner generate assignment notification 312 for customer, assignment owner can re-generate notification multiple times if requested by customer. Once trust is established at step 314, the assignment owner can talk 316 to the customer related to the assignment's purpose. The assignment owner can also capture assignment outcomes 318, next steps, and customer feedback in the system.

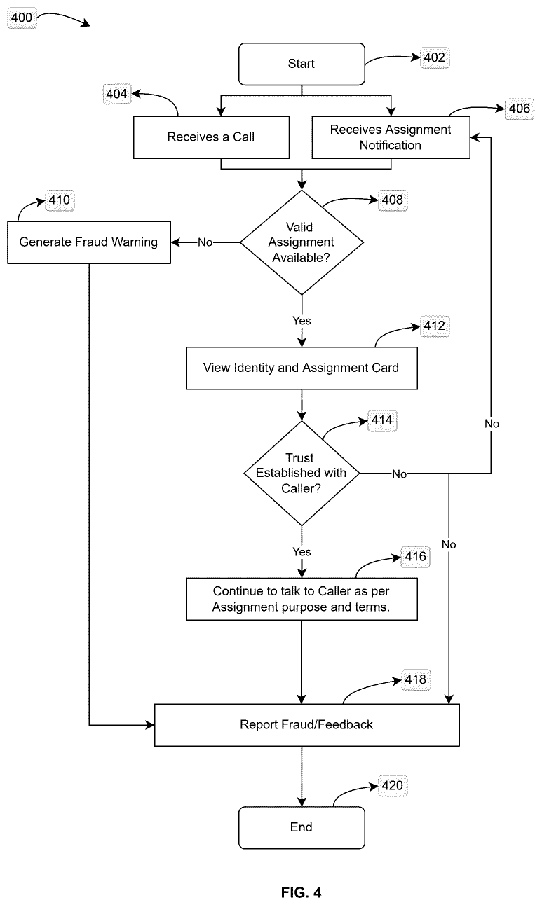

Reference is made now to FIG. 4 from customer perspective, illustrating an embodiment 400 of the present invention wherein the process starts by assignment owner calling 404 the customer and introducing themselves and request the customer to validate their identity over system to establish trust. The assignment owner logs in to the system with business SSO and views the assigned assignment. Assignment owner generates an identity token on the system which sends the notification 406 to the client over call, email, SMS, or other available communication channel. Customer open notification and validate 408 if assignment is available. If the assignment owner's identity and assignment are valid, the customer will see an assignment card at step 412 with the name of the assignment owner, employment type, ID, purpose of call, privacy, and terms of the assignment. Once trust is established, the assignment owner can talk 416 to the customer related to the assignment's purpose. This helps customers avoid sharing information that is not needed. If the assignment owner and assignment are not valid, the customer will see a fraud alert 418 and the option to report it to the agency. Trust is established between the assignment owner and customer for valid assignment owner identity and assignment, and fraud is prevented with the alert. The system provides a secure and efficient means of identity verification that is user-friendly and convenient for both businesses and their customers.

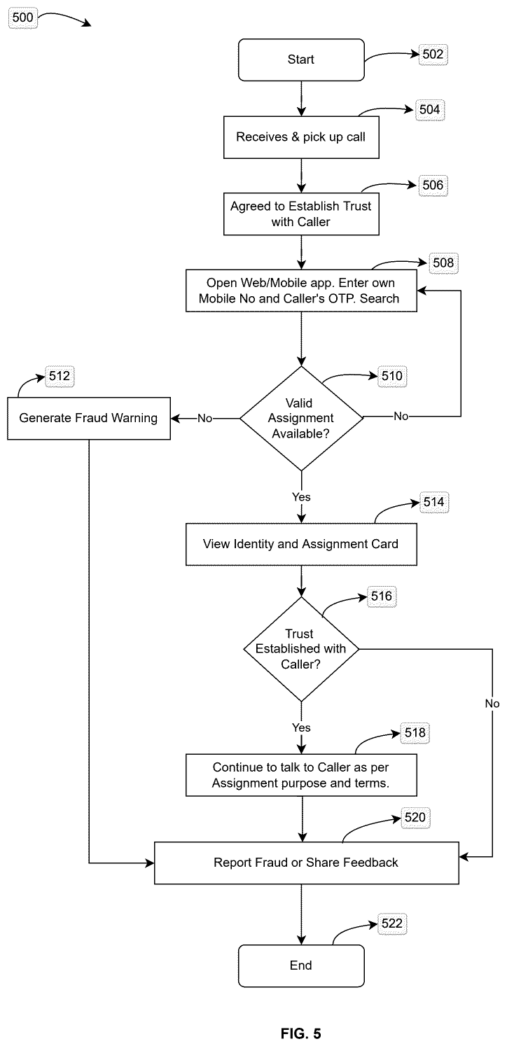

Reference is made now to FIG. 5 from customer perspective without an installed mobile app, illustrating an embodiment 500 of the present invention wherein the process starts by user picking up the call 504 of assignment owner/caller who introduce themselves and request the customer to validate their identity over system to establish trust 506. Customer opens a system website/mobile app 508 and enter own mobile number and one-time-password shared by assignment owner/caller, the availability of valid assignment 510 is checked and if the assignment is not valid a fraud warning 512 is generated and previous step 508 is executed if needed. If a valid assignment is available, and trust 516 is established then the customer view assignment details and then further continue to talk to caller as per assignment purpose and terms 518. Assignment details includes assignment card with the name of the assignment owner, employment type, ID, purpose of call, privacy, and terms of assignment. For valid assignments, customer can provide feedback 520 (if any). For invalid assignments, customer can report fraud 520 if needed.

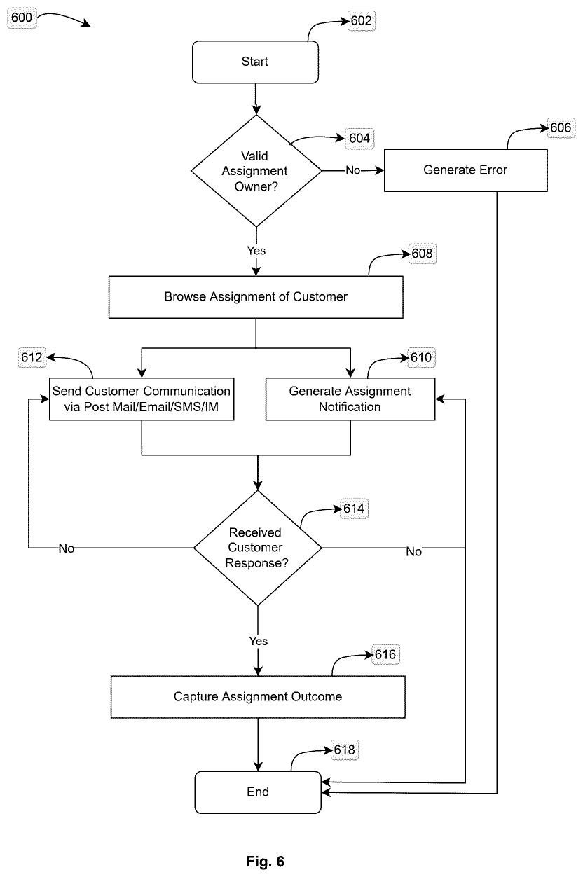

Reference is now made to FIG. 6 from assignment owner perspective for use cases other than phone/IP call e.g. post mail, email, sms, text, instant messaging (IM) apps like WhatsApp, Telegram illustrating an embodiment 600 of the present invention wherein the process starts 602 by checking the validity 604 of assignment owner and if the assignment owner is not valid then an error 606 is generated by the system hence ending the process. If the assignment owner is log in to the system with business SSO and valid then assignment owner browses 608 for customer assignment. Assignment owner communicates with customer via post mail, email or text, sms & instant messaging apps 612 and simultaneously generate assignment notification 610. Assignment owner wait for customer response 614. If received, then capture assignment outcome 616 else assignment owner could resend communication 612 and notification 610. Assignment owner can also re-generates assignment notification 610 if requested by user. After receiving communication from customer, the assignment owner capture assignment outcomes 616, next steps, and customer feedback in the system.

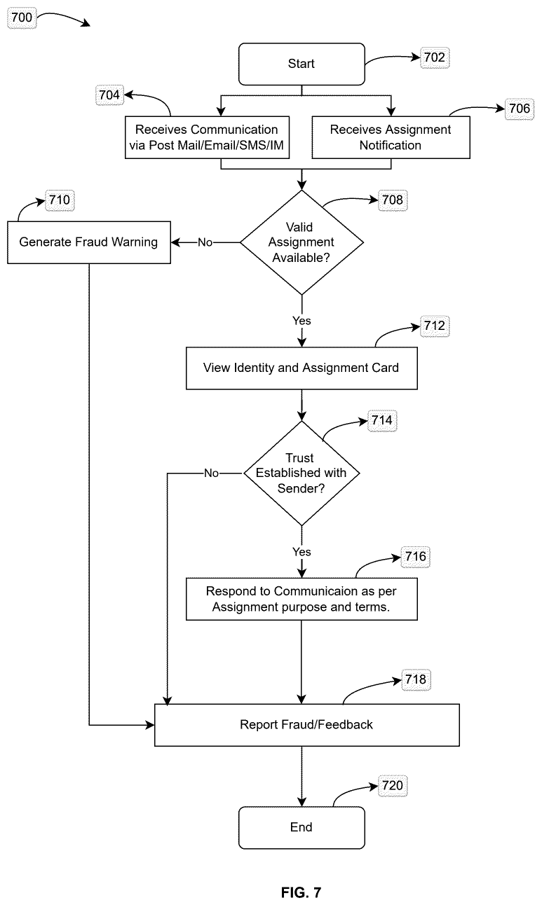

Reference is now made to FIG. 7, illustrating an embodiment 700 of the present invention wherein process starts by receiving communication 704 via multiple mediums including but not limited to post mail, sms, text, instant messaging apps, etc. The customer receives assignment notification 706 with identity token for identity verification of the assignment and assignment owner. If the assignment is not valid then a fraud warning 718 is generated and if the assignment is valid the assignment identity and assignment card is viewed 712 and the trust is established 714 between assignment owner and customer for valid assignment owner identity and assignment. Once trust is established then customer can respond to communication as per the assignment's purpose 716. After receiving communication from customer, the assignment owner capture assignment outcomes, next steps, and customer feedback in the system.

The unique feature of the invention is that the caller introduction, purpose, and verification are achieved in a single session, making the identity verification process secure, efficient, and user-friendly. There are several advantages of the invention including but not limited to:
Enhanced security: The invention provides a secure way to verify the identity of customer service agents and callers, which helps to prevent fraud and protect customer privacy. This can also prevent deceitful persons or entities from posing as legitimate business representatives to extort money or other benefits from customers.
Streamlined identity verification: Traditional methods of identity verification, such as presenting identification documents or answering security questions, can be cumbersome and time-consuming. The present invention streamlines the identity verification process for businesses and their customers, making it user-friendly and convenient.
Efficient communication: The present invention enables businesses to assign customer service tasks to their agents securely, and enables customers to verify the identity of the agent who contacts them. This can facilitate efficient communication between businesses and their customers.
Improved customer experience: The present invention helps to establish trust between customers and businesses, which can lead to improved customer satisfaction and loyalty. It also helps customers to avoid sharing information that is not needed, which can improve their overall experience with the business.

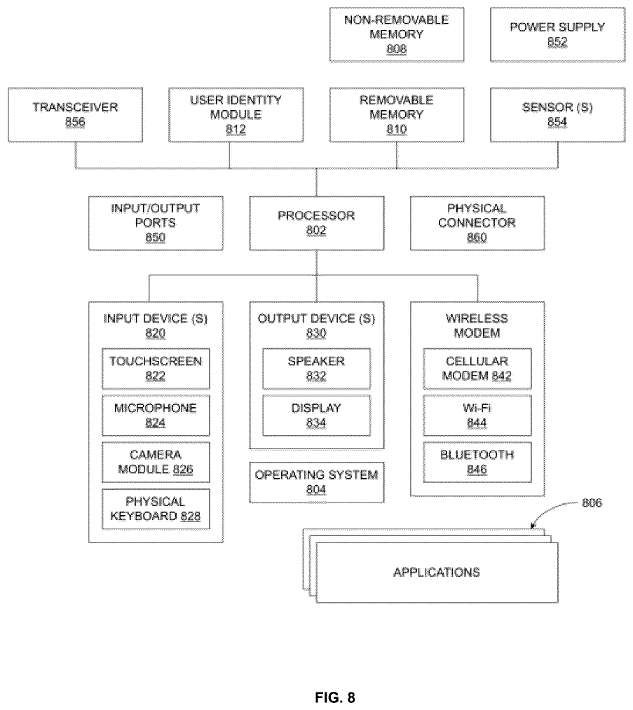

FIG. 8 shows a simplified block diagram of a user device 800, for example, a mobile phone or a desktop computer capable of implementing the various embodiments of the present disclosure. For example, the user device 800 may correspond to client devices associated with plurality of terminals 102a, 102b, to 102n that can log in to the system with their mobile number and enter the identity token to view the assignment details.

It should be understood that the user device 800 as illustrated and hereinafter described is merely illustrative of one type of device and should not be taken to limit the scope of the embodiments. As such, it should be appreciated that at least some of the components described below in connection with the user device 800 may be optional and thus in an example embodiment may include more, less or different components than those described in connection with the example embodiment of the FIG. 8. As such, among other examples, the user device 800 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the user device 800. In addition, the applications 806 may include common server performance monitoring applications or any other computing application.

The illustrated user device 800 includes one or more memory components, for example, a non-removable memory 808 and/or removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the applications 806. The user device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to a speaker 832 and a display 834. Other possible output devices can include piezoelectric or other haptic output devices. Some devices can serve more than one 10 input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the user device 800 and a public switched telephone network (PSTN).

The user device 800 can further include one or more input/output ports 850, a power supply 852, one or more sensors 854, for example, an accelerometer, a gyroscope, a compass, or an infrared proximity sensor for detecting the orientation or motion of the user device 800 and biometric sensors for scanning biometric identity of an authorized user, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein-and in particular embodiment specifically contemplated, is intended to be practiced in the absence of any element which is not specifically disclosed herein.

1. A system for identity and assignment verification comprising various roles including but not limited to assignment management, assignment approval, and assignment ownership wherein:
the assignment management facilitates creation of service assignments for customer service agents and callers.
the assignment approver facilitates approving or rejecting the assignments.
the assignment ownership facilitates, viewing assigned assignments, generating an identity token, and communicating it to the client over call, email, SMS, or other communication channels if a customer requests identity verification.

2. A computer-implemented method for identity and assignment verification of customer service agents and callers comprising the steps wherein:
the assignment manager logs in to the system and creates service assignments for customers, including identifying information such as customer ID, assignment owner name, photo, employment type, employee id, assignment validity, purpose, privacy, and terms of assignment.
the assignment approver logs in to the system and approves or rejects the service assignment;
the assignment owner (a.k.a agent/caller) logs in to the system to view the assigned assignment and generate an identity token on the system and communicates it to the client via a communication medium;
when assignment owner calls the customer over the phone, he gives a brief introduction and requests the customer to validate his identity over the system to establish trust and if the trust is established assignment owner talks to the customer related to the assignment purpose;
after communication with customer assignment owner captures assignment outcome, next steps, and customer feedback in the system;
the customer logs in to the system with its user id e.g. mobile number/email/others and enters the identity token to view assignment details to see whether identity and assignment purpose of assignment owner are valid, then customer will see the assignment card that has the name of Assignment Owner, employment type, ID, purpose of the call, privacy, and terms of assignment; and
if assignment owner and assignment are not valid, then customer will see a fraud alert and an option to report it to an agency.

3. A computer-implemented method according to claim 2, wherein the caller introduction, purpose of call and assignment verification are achieved in a single session.

4. The method according to claim 2, wherein the communication medium may include but not limited to phone calls, VOIP calls, post mail, instant messaging apps, SMS, MMS, multimedia message etc.
